(19) United States
(12) Patent Application Publication
(10) Pub. No.: US 2024/0396421 A1
(43) Pub. Date: Nov. 28, 2024

(54) CURRENT REGULATOR SYSTEM

(71) Applicant: TEXAS INSTRUMENTS INCORPORATED, Dallas, TX (US)

(72) Inventors: Ivan Shumkov, Freising (DE); Erich-Johann Bayer, Freising (DE); Ruediger Ganz, Freising (DE)

(21) Appl. No.: 18/791,602

(22) Filed: Aug. 1, 2024

Related U.S. Application Data
(62) Division of application No. 18/143,808, filed on May 5, 2023, now Pat. No. 12,088,184.
Application No. 18/143,808 is a division of application No. 17/136,442, filed on Dec. 29, 2020, now Pat. No. 11,682,961.
(60) Provisional application No. 62/984,049, filed on Mar. 2, 2020.

(51) Int. Cl. H02M 1/00; H02M 3/158

(52) U.S. Cl. CPC H02M 1/0009; H02M 3/1582

(57) ABSTRACT

An example of a power supply system includes a switching voltage regulator comprising at least one switch configured to conduct an input current to generate an output voltage responsive to a switching signal and based on an input voltage. The system also includes a current regulator configured to generate a current sample voltage based on an amplitude of the input current relative to a reference current defining a maximum average amplitude setpoint of the input current to set a switching time defining a switching period of the at least one switch. The system also includes a switch controller configured to provide the switching signal to control the at least one switch based on an amplitude of the output voltage relative to a reference voltage and based on the switching time.

### CROSS-REFERENCE TO RELATED APPLICATION

This application is a divisional of U.S. application Ser. No. 18/143,808 filed May 5, 2024, which is a divisional of U.S. application Ser. No. 17/136,442 filed Dec. 29, 2020, now U.S. Pat. No. 11,682,96, granted Jun. 20, 2023, which claims priority to U.S. Provisional Application No. 62/984,049, filed Mar. 2, 2020, all of which are incorporated herein by reference in their entirety.

### TECHNICAL FIELD

This description relates generally to electronic circuits, and more particularly to a current regulator system.

### BACKGROUND

Power supply circuits can be implemented in a variety of different ways. Examples of power supply circuits include synchronous rectifier power converters, asynchronous rectifier power converters, resonant power converters, and any of a variety of other types of switching power converters. A typical power supply circuit can thus activate one or more switches to convert an input voltage to an output voltage. Power supply circuits are typically implemented in wireless electronic devices. As a result, the input voltage is typically provided by a battery. Thus, the operational life of the battery is typically limited by the amplitude of the input current that is provided from the input voltage to generate the output voltage in the power supply circuit. For example, in a switching power supply circuit that provides current through an inductor, the operational life of the battery can be based on an average amplitude of the input current through an operating cycle of the switching power supply circuit.

### SUMMARY

An example circuit includes a switching voltage regulator having a first input, a second input, and an output. The first input is coupled to a source of an input current. A current regulator has an input, a first output and a second output. The input is coupled to the source of the input current. The current regulator provides at the first output a comparison signal having a logic state responsive to a current sampling voltage. The current regulator provides a reference current at the second output proportional to a maximum average amplitude setpoint of the input current over a switching period of the switching voltage regulator. A switch controller has a first input, a second input, a third input and an output, the first input coupled to the first output of the current regulator circuit. The second input is coupled to the output of the switching voltage regulator, and the third input is adapted to be coupled to a reference voltage source. The output is coupled to the second input of the switching voltage regulator.

An example of a power supply system includes a switching voltage regulator comprising at least one switch configured to conduct an input current to generate an output voltage responsive to a switching signal and based on an input voltage. The system also includes a current regulator configured to generate a current sample voltage based on an amplitude of the input current relative to a reference current defining a maximum average amplitude setpoint of the input current to set a switching time defining a switching period of the at least one switch. The system also includes a switch controller configured to provide the switching signal to control the at least one switch based on an amplitude of the output voltage relative to a reference voltage and based on the switching time.

An example of an integrated circuit (IC) includes a switching voltage regulator comprising at least one switch configured to conduct an input current to generate an output voltage responsive to a switching signal and based on an input voltage. The IC also includes a current regulator configured to generate a current sample voltage across a sampling capacitor. The current sample voltage can be based on an amplitude of the input current relative to a reference current that is set at a first external pin and which is proportional to a maximum average amplitude setpoint of the input current to set a switching time defining a switching period of the at least one switch. The IC includes an input pin adapted to be coupled to a source of the reference current. The IC further includes a switch controller configured to provide the switching signal to control the at least one switch based on the switching time and based on an amplitude of the output voltage relative to a reference voltage that is set at a second external pin.

### BRIEF DESCRIPTION OF THE DRAWINGS

FIG. 1 is an example of a block diagram of a power supply system.

FIG. 2 is an example of a schematic electrical circuit diagram of a power supply circuit.

FIG. 3 is an example of timing diagrams.

FIG. 4 is another example of timing diagrams.

FIG. 5 is an example of a schematic electrical circuit diagram of current flow in a power supply circuit.

FIG. 6 is another example of a schematic electrical circuit diagram of current flow in a power supply circuit.

FIG. 7 is another example of a schematic electrical circuit diagram of a power supply circuit.

FIG. 8 is another example of a schematic electrical circuit diagram of current flow in a power supply circuit.

FIG. 9 is another example of a schematic electrical circuit diagram of current flow in a power supply circuit.

FIG. 10 is another example of a schematic electrical circuit diagram of current flow in a power supply circuit.

FIG. 11 is another example of a schematic electrical circuit diagram of current flow in a power supply circuit.

FIG. 12 is another example of a schematic electrical circuit diagram of current flow in a power supply circuit.

FIG. 13 is another example of a schematic electrical circuit diagram of current flow in a power supply circuit.

### DETAILED DESCRIPTION

This description relates generally to electronic circuits, and more particularly to a current regulator system. The current regulator system can be included in a power supply system, such as a switching power supply system. The power supply system can also include a switching voltage regulator that includes at least one switch that is controlled by a switch signal to provide an input current from an input voltage and through an inductor to generate an output voltage. The power supply system further includes a switch controller that is configured to generate the switch signal, such as based on the output voltage relative to a reference voltage, and to a current sampling voltage that has an amplitude associated with a switching time of the switching voltage regulator to regulate an amplitude of the input current.

As an example, the input voltage is provided from a battery. Therefore, the current regulator system can be configured to regulate the amplitude of the input current to mitigate current draw from the battery, and to therefore extend the operating life of the battery. The current regulator system can include a sampling capacitor that is configured to generate the current sampling voltage that is based on a sampling current. The sampling current can be based on a charging current that is associated with the input current and a reference current. As one example, the charging current is generated based on the input current and which is proportional to the input current. As another example, the charging current is a current that has a fixed amplitude that is estimated to be proportional to the input current. The reference current can have an amplitude that is proportional to a maximum average amplitude setpoint of the input current over a switching period.

The current sampling voltage can have an amplitude that is based on the amplitude of the charging current minus a reference current during a first switching phase of the switching voltage regulator. For example, the reference current is arranged to flow from the sampling capacitor. Thus, during the first switching phase of the switching voltage regulator, the amplitude of the current sampling voltage can increase. During a second switching phase of the switching voltage regulator, the amplitude of the current sampling voltage can be based on the reference current only, such that the amplitude of the current sampling voltage can decrease during the second switching phase of the switching voltage regulator. The duration of time between the beginning of charging of the sampling capacitor in the first sampling phase to the end of the discharging of the sampling capacitor in the second sampling phase (e.g., between equal charges of approximately zero) can define the switching time of the switching voltage regulator. Thus, the switch controller can monitor the amplitude of the current sampling voltage to switch between the switching phases of the switching voltage regulator, and to thus regulate the amplitude of the output voltage and the input current.

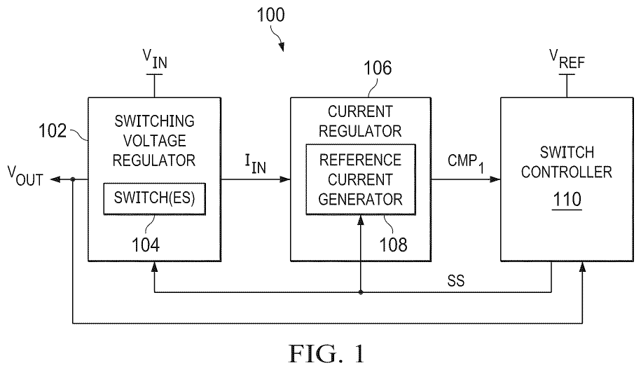

FIG. 1 is an example of a block diagram of a power supply system 100. The power supply system 100 can be implemented in any of a variety of wireless electronic devices, such as laptop computers, tablet computers, smart phones, or any of a variety of other electronic devices. The power supply system 100 is configured to generate an output voltage V_{OUT} from an input voltage V_{IN}. As an example, the input voltage V_{IN} is provided from a battery. As described herein, the power supply system 100 can provide regulation of an input current I_{IN} that is drawn from a battery to mitigate an average amplitude of the input current I_{IN}, and therefore to extend the operational life of the battery. As an example, the power supply system 100 is fabricated on or as part of an integrated circuit (IC).

The power supply system 100 includes a switching voltage regulator 102 that includes at least one switch 104 that is controlled by a respective at least one switching signal, shown in the example of FIG. 1 as a signal SS, to generate the output voltage V_{OUT} based on the input voltage V_{IN}. As an example, the switching voltage regulator 102 operates as a buck regulator or a boost regulator, and/or operates in buck and boost modes, to generate the output voltage VOLT. For example, the switch(es) 104 include a high-side switch (e.g., P-channel field effect transistor (PFET)) and a low-side transistor (e.g., N-channel field effect transistor (NFET)) that are alternately activated to provide current through an inductor to generate the output voltage V_{OUT} at an output of the switching voltage regulator 102. As described herein, the activation of the switch(es) 104 can be defined by switching phases, such as a first switching phase and a second switching phase, that define changes in the current through the inductor and which collectively define a switching period of the switching voltage regulator 102.

The power supply system 100 also includes a current regulator system 106 that is configured to regulate an amplitude of the input current I_{IN}. As described above, the input current I_{IN} can be drawn from a battery, such that monitoring and regulating the amplitude of the input current I_{IN} can result in an extension of the operational life of the battery. In the example of FIG. 1, the current regulator system 106 includes a reference current generator 108 that is configured to generate a reference current that has an amplitude that is proportional to a maximum average amplitude setpoint of the input current I_{IN} over a switching period. As an example, the reference current generator 108 is set at an external pin of the associated IC on which the power supply system 100 is fabricated (e.g., as a grounded resistor).

The current regulator system 106 can include a sampling capacitor that is configured to generate a current sampling voltage V_{SMPL} that is based on a charging current that is associated with the input current I_{IN} and based on the reference current. As one example, the charging current is a current that is generated based on the input current I_{IN} and which is proportional to the input current I_{IN}. As another example, the charging current is a current that has a fixed amplitude that is estimated to be proportional to the input current. For example, the charging current and the reference current are each proportioned in amplitude with respect to the input current I_{IN}, such that the reference current is proportional to the maximum average amplitude setpoint of the input current Is over a switching period.

As an example, the current sampling voltage V_{SMPL} has an amplitude that is based on the amplitude of the charging current minus the reference current during a first switching phase of the switching voltage regulator 102, such as defined by the switching signal(s) SS. For example, the reference current flows from the sampling capacitor to pull current away from the charging current that is provided to the sampling capacitor. Thus, during the first switching phase of the switching voltage regulator 102, the amplitude of the current sampling voltage V_{SMPL} can increase, and can be proportional to the sensed amplitude of the input current I_{IN}. During a second switching phase of the switching voltage regulator 102, the amplitude of the current sampling voltage V_{SMPL} can be based on the reference current but not on the charging current. For example, the switching signal(s) SS can include signals that operate switches to control the charging current being provided to the sampling capacitor. Therefore, the amplitude of the current sampling voltage V_{SMPL} can decrease during the second switching phase of the switching voltage regulator 102, and can therefore be proportional to the target regulation amplitude of the input current I_{IN}.

For example, the current regulator system 106 includes a sampling comparator that is configured to identify approximately zero volts across the sampling capacitor, and thus an approximate zero voltage amplitude of the current sampling voltage V_{SMPL}. As described herein, the term “approximately” can include some deviation from an exact value (e.g., +/−5%). Therefore, the sampling comparator can identify an approximately equal amplitude of the current sampling voltage V_{SMPL} across the sampling capacitor at the beginning and end of a given switching period of the switching voltage regulator 102. In the example of FIG. 1, the output of the sampling comparator is shown as a comparison signal CMP₁.

The power supply system 100 further includes a switch controller 110. The switch controller 110 is configured to provide the switching signal(s) SS responsive to the comparison signal CMP₁. For example, the sampling comparator monitors the amplitude of the current sampling voltage V_{SMPL} to switch from the second switching phase of the switching voltage regulator 102 to the first switching phase of the switching voltage regulator 102, and thus to a next switching period of the switching voltage regulator 102. The next switching period can also be initiated based on an amplitude of the output voltage V_{OUT} relative to a reference voltage V_{REF}. As an example, the reference voltage V_{REF} can be set at an external pin of the associated IC on which the power supply system 100 is fabricated (e.g., as a fixed voltage source). Therefore, the switch controller 110 can control the switching time of the switching voltage regulator 102 based on the amplitude of the current sampling voltage V_{SMPL}. For example, the switch controller 110 also includes a state machine that is configured to generate the switching signal(s) SS, such as based on the amplitude of the current sampling voltage V_{SMPL} and the amplitude of the output voltage V_{OUT} relative to the reference voltage V_{REF}.

As a result of the switch controller 110 controlling the switching period of the switching voltage regulator 102 based on the current sampling voltage V_{SMPL}, the power supply system 100 can regulate the amplitude of the input current I_{IN} to mitigate the power consumption from the associated battery, thereby extending the operational life of the battery. For example, by implementing the reference current generator 108 to pull the reference current from the sampling capacitor and providing the switching period transition on the time between a beginning amplitude of the current sampling voltage V_{SMPL} in the first switching phase is approximately equal to a final amplitude of the current sampling voltage V_{SMPL} in the second switching phase, the power supply system 100 can reduce the average amplitude of the input current I_{IN} through the switching period of the switching voltage regulator 102. Accordingly, the power supply system 100 can extend the operational life of the battery that provides the input voltage V_{IN}. Additionally, as described in greater detail herein, the power supply system 100 can operate in any of a variety of waveforms of the current through the inductor of the switching voltage regulator 102.

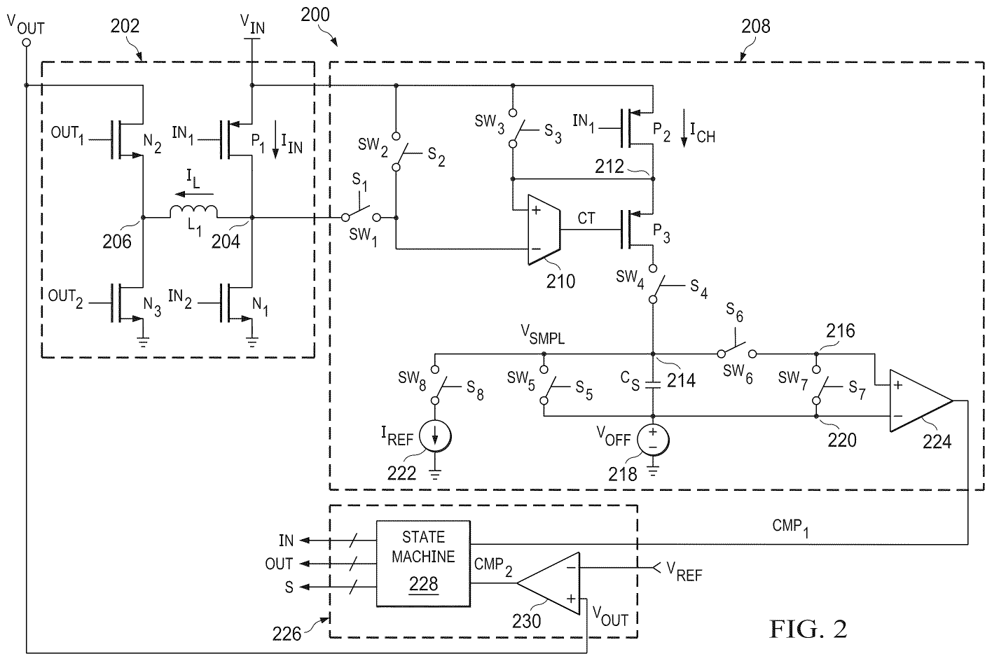

FIG. 2 is an example of a schematic electrical circuit diagram of a power supply circuit 200. The power supply circuit 200 can be implemented in any of a variety of wireless electronic devices, such as laptop computers, tablet computers, smart phones, or any of a variety of other electronic devices. The power supply circuit 200 is configured to generate an output voltage V_{OUT} from an input voltage V_{IN}. The power supply circuit 200 can be the power supply system 100 in the example of FIG. 1. Therefore, reference is to be made to the example of FIG. 1 in the following description of the example of FIG. 2.

The power supply circuit 200 includes a switching voltage regulator 202. The switching voltage regulator 202 includes a high-side switch, shown as a PFET P₁, a low-side switch, shown as an NFET N₁, a first output switch, shown as an NFET N₂, and a second output switch, shown as an NFET N₃. The PFET P₁ interconnects the input voltage V_{IN} at a source and a switching node 204 at a drain, and the NFET N₁ interconnects the switching node 204 at a drain and a low-voltage rail, shown in the example of FIG. 2 as ground, at a source. The NFET N₂ interconnects the output voltage V_{OUT} at a drain and a switching node 206 at a source, and the NFET N₃ interconnects the switching node 206 at a drain and the low-voltage rail at a source. An inductor L₁ interconnects the switching nodes 204 and 206 and is configured to conduct a current I_{L}.

The PFET P₁ is controlled by a switching signal IN₁, the NFET N₁ is controlled by a switching signal IN₂, the NFET N₂ is controlled by a switching signal OUT₁, and the NFET N₃ is controlled by a switching signal OUT₂. The activation of the FETs P₁, N₁, N₂, and N₃ in a sequence provides the current I_{L} through the inductor L₁ in switching phases defined by the switching signals IN₁, IN₂, OUT₁, and OUT₂, respectively. For example, the activation of the PFET P₁ and NFET N₃ provides the input current I_{IN} to flow from the input voltage V_{IN} to the switching node 204 during the first switching phase based on the switching signal IN₁ and OUT₂, such that the current I_{L} is approximately equal to the input current I_{IN} during the first switching phase of the switching voltage regulator 202. During the second switching phase of the switching voltage regulator 202, the PFET P₁ and NFET N₃ are deactivated and the NFET N₁ and NFET N₂ are activated by the switching signal IN₂ and OUT₁ to conduct the current I₁, from the low-voltage rail through the inductor L₁.

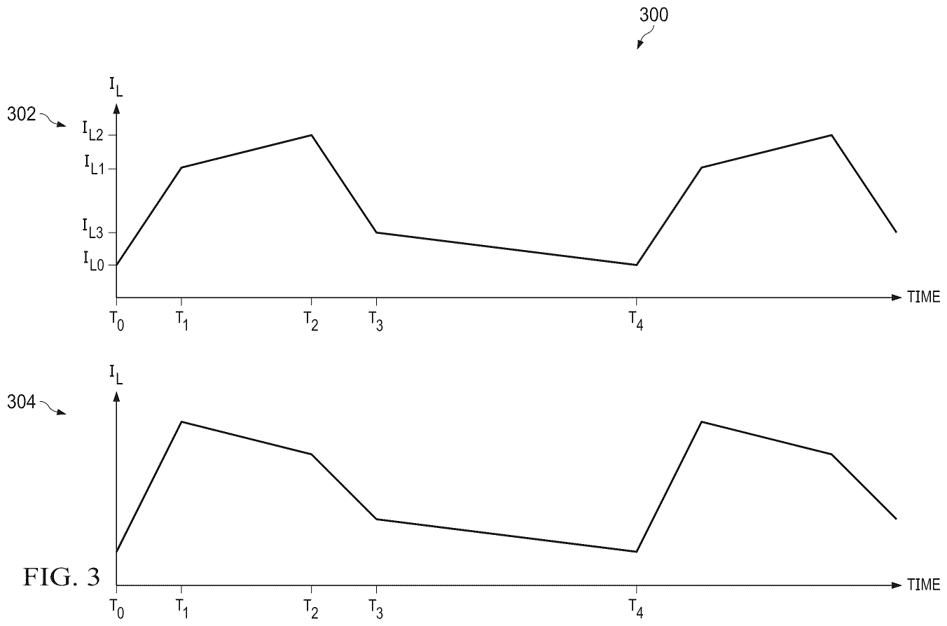

FIG. 3 is an example of timing diagrams. The timing diagrams include a first timing diagram 302 that shows inductor current I_{L} plotted as a function of time for a converter operating in buck mode, and a second timing diagram 304 that shows inductor current I_{L} plotted as a function of time for a converter operating in boost mode. The inductor current I_{L}, can be the current through the inductor L₁ of the switching voltage regulator 202 in the example of FIG. 2. Therefore, reference is to be made to the example of FIG. 2 in the following description of the example of FIG. 3. For simplicity sake, the transition times of the timing diagrams 302 and 304 are aligned. However, the transition times can differ between the buck and boost modes.

In the first timing diagram 302, the switching voltage regulator 202 begins a first switching phase at a time T₀. At the time T₀, the PFET P₁ and the NFET N₃ are activated by the switching signals IN₁ and OUT₂, respectively. Therefore, the input current I_{IN} flows from the input voltage V_{IN}, through the PFET P₁, and through the inductor L₁ as the current I_{L}, and through the NFET N₃. Thus, in the example of FIG. 3, the current I_{L} is demonstrated as increasing from an amplitude of I_{L0}, which is an amplitude greater than or equal to zero, to an amplitude I_{L1} at a time T₁. At the time T₁, the NFET N₃ is deactivated by the switching signal OUT₂ and the NFET N₂ is activated by the switching signal OUT₁. Therefore, the input current I_{IN} flows from the input voltage V_{IN}, through the PFET P₁, and through the inductor L₁ as the current I_{L}, and through the NFET N₂, such as to charge an output capacitor (not shown in the example of FIG. 2). Thus, in the example of FIG. 3, the current I₁, is demonstrated as increasing from the amplitude I_{L1} to an amplitude I_{L2} at a time T₂, and thus at a lesser slope than between the times T₀ and T₁.

The switching voltage regulator 202 switches from the first switching phase to the second switching phase at the time T₂. At the time T₂, the PFET P₁ is deactivated and the NFET N₁ is activated by the switching signals IN₁ and IN₂, respectively, and the NFET N₂ remains activated. Therefore, the input current I_{IN} ceases, and the current I_{L} flows from the low-voltage rail, through the NFET N₁, through the inductor L₁, and through the NFET N₂. Thus, in the example of FIG. 3, the current I_{L} is demonstrated as decreasing from the amplitude I_{L2} to an amplitude I_{L3} at a time T₃, with the amplitude I_{L3} being less than the amplitude I_{L1}. At the time T₃, the NFET N₂ is deactivated by the switching signal OUT₁ and the NFET N₃ is activated by the switching signal OUT₂. Therefore, the current I_{L}, flows from the low-voltage rail, through the NFET N₁, through the inductor L₁, and through the NFET N₃. Thus, in the example of FIG. 3, the current I_{L} is demonstrated as decreasing from the amplitude I_{L3} to the initial amplitude I_{L0} at a time T₄. The second switching phase concludes at the time T₄. The first and second switching phases can define a switching period, such that a next switching period is shown in the example of FIG. 3 as beginning at the time T₄. For example, an idle time at which the current I_{L} remains at zero can occur between switching periods, such as during deactivation of the power supply circuit 200 or in a discontinuous mode of operation of the power supply circuit 200.

The second timing diagram 304 is arranged similar to the first timing diagram 302, and can define a boost mode of operation of the power supply circuit 200. As an example, the boost mode of operation is based on a variation in topology of the power supply circuit 200 to vary the amplitude of the current I_{L}. The second timing diagram 304 is therefore shown to demonstrate that the principle of operation of the power supply circuit 200, as described herein, is applicable to any of a variety of inductor current waveforms.

Referring back to the example of FIG. 2, the power supply circuit 200 includes a current regulator system 208 that is configured to regulate an amplitude of the input current I_{IN}. As described above, the input current I_{IN} can be drawn from a battery, such that monitoring and regulating the amplitude of the input current I_{IN} can result in an extension of the operational life of the battery. In the example of FIG. 2, the current regulator system 208 includes a transconductance amplifier 210 that has a first input that is coupled to the switching node 204 through a first switch SW₁ controlled by a switching signal S₁ and to the input voltage V_{IN} through a second switch SW₂ controlled by a switching signal S₂. The transconductance amplifier 210 also has a second input that is coupled to the input voltage V_{IN} through a third switch SW₃ controlled by a switching signal S₃ and to a third switching node 212. The third switching node 212 is coupled to the input voltage V_{IN} through a PFET P₂. As an example, the PFET P₂ is a replica switch with respect to the PFET P₁, such that the PFET P₂ has a channel width that is scaled-down by a factor of K relative to the PFET P₁. In the example of FIG. 2, the PFET P₂ is activated by the switching signal IN₁, such that the PFET P₂ is activated concurrently with the PFET P₁ to generate a charging current I_{CH} that has an amplitude approximately equal to the amplitude of the input current I_{IN} divided by K (e.g., I_{CH}=I_{IN}/K).

The transconductance amplifier 210 is configured to generate a signal CT that is provided to a PFET P₃ to provide the charging current I_{CH} to a sampling node 214 through a switch SW₄ controlled by a switching signal S₄. A sampling capacitor C_{S} interconnects the sampling node 214 and a node 220. The sampling node 214 and the node 220 are also coupled by a switch SW₅ that is controlled by a switching signal S₅. A voltage source 218 provides an offset voltage V_{OFF} to the node 220. Additionally, a switch SW₆ that is controlled by a switching signal S₆ interconnects the sampling node 214 and a node 216, and a switch SW₇ that is controlled by a switching signal S₇ interconnects the nodes 216 and 220.

The current regulator system 208 also includes a current source 222 that is coupled to the sampling node 214 through a switch SW₈ that is controlled by a switching signal S₈. The current source 222 be the reference current generator 108 in the example of FIG. 1. For example, the current source 222 is provided at an external pin of the associated IC on which the power supply circuit 200 is fabricated (e.g., as a grounded resistor). Therefore, when the switch SW₈ is closed, the current source 222 is configured to conduct the reference current I_{REF} from the sampling node 214, and thus from the sampling capacitor C_{S}. For example, the offset voltage V_{OFF} (e.g., approximately 350 mV) provides sufficient headroom for the reference current I_{REF}. As described above, the reference current I_{REF} can have an amplitude that is proportional to a maximum average amplitude setpoint of the input current I_{IN} over a switching period of the switching voltage regulator 202. For example, the proportionality of the reference current I_{REF} to the maximum average amplitude setpoint of the input current I_{IN} is likewise scaled by the factor of K, and thus the proportionality constant as the charging current I_{CH}. As an example, the reference current I_{REF} has an amplitude that is expressed as follows:

$${I}_{REF} = {I}_{TAR} / K \qquad Euation 1$$

Where: I_{TAR} is the maximum average amplitude setpoint of the input current I_{IN} over a switching period of the switching voltage regulator 202.

The current regulator system 208 also includes a sampling comparator 224 that has inputs at the nodes 216 and 220. The sampling comparator 224 is therefore configured to monitor the sampling voltage V_{SMPL} on the sampling capacitor C_{S} when the switch SW₆ is closed (e.g., based on common mode operation defined by the offset voltage V_{OFF}). The sampling comparator 224 can generate a first comparison signal CMP₁ responsive to determining that the sampling voltage V_{SMPL} has an amplitude of approximately zero.

The power supply circuit 200 further includes a switch controller 226. The switch controller 226 includes a state machine 228. The first comparison signal CMP₁ is provided to the state machine 228 that also receives a second comparison signal CMP₂ from a reference comparator 230. In the example of FIG. 2, the reference comparator 230 is configured to compare the output voltage V_{OUT} with a fixed reference voltage V_{REF}. Based on the comparison signals CMP₁ and CMP₂, the state machine 228 can generate the switching signals IN, OUT, and S that are provided to the respective PFETs P₁ through P₃, the NFETs N₁ through N₃, and the switches SW₁ through SW₈. Therefore, the state machine 228 can define the first and second switching phases of the switching voltage regulator 202, and therefore the switching period of the switching voltage regulator 202. The state machine 228 can also provide the controls for operating the switches SW₁ through SW₈ to provide the operation of the current regulator system 208 in each of the first and second switching phases to regulate the amplitude of the input current I_{IN}.

The example power supply circuit 200 can be configured differently than shown in the example of FIG. 2. For example, the switching voltage regulator 202 is not limited to the arrangement of the high and low-side switches P₁, N₁, N₂, and N₃. As one example, the PFET P₁, and by extension the replica PFET P₂, is arranged as N-channel transistors instead.

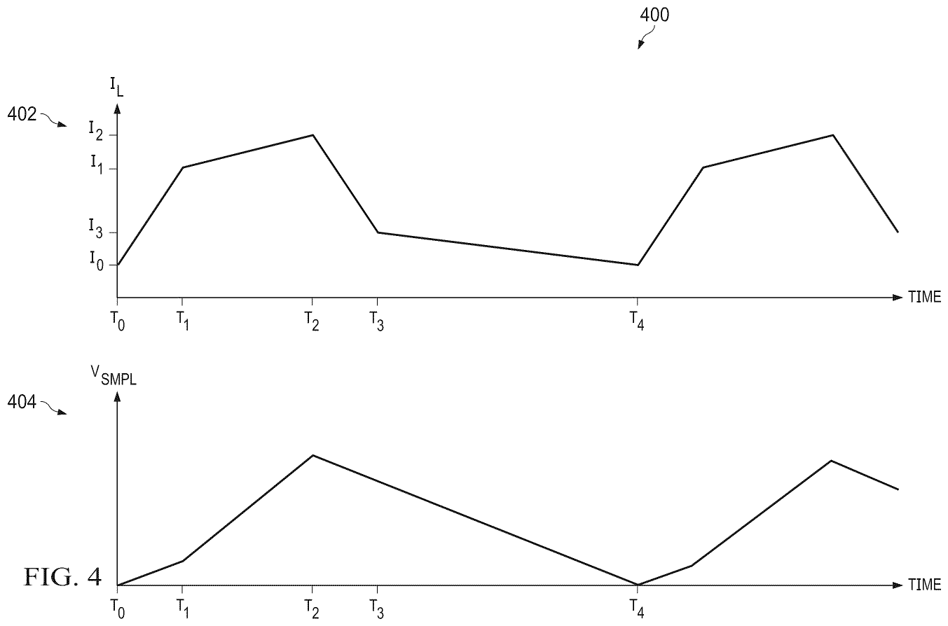

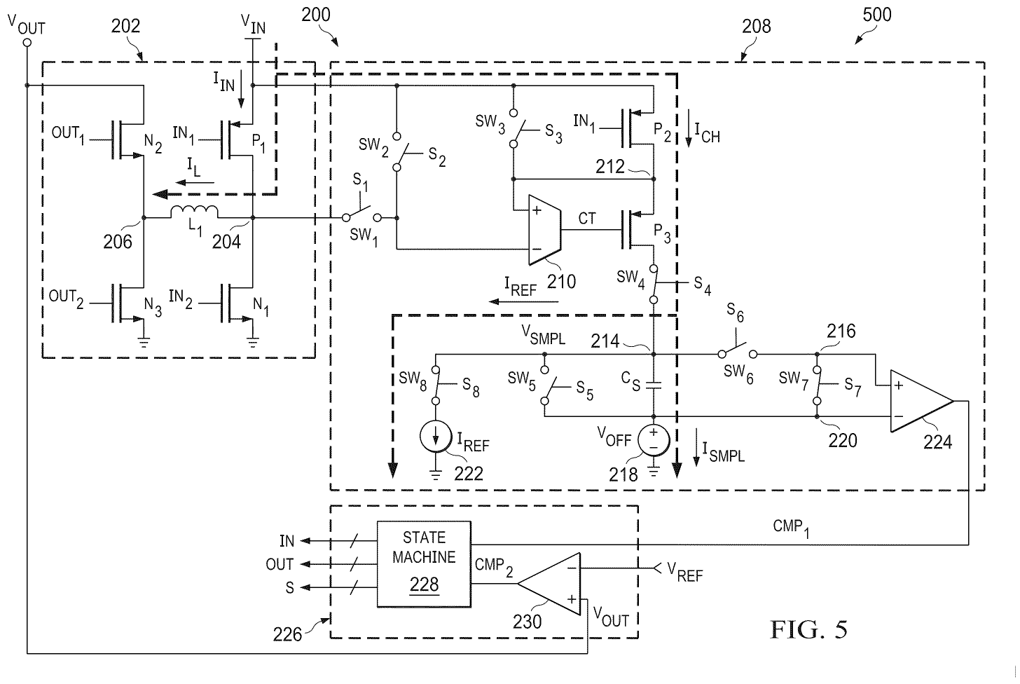

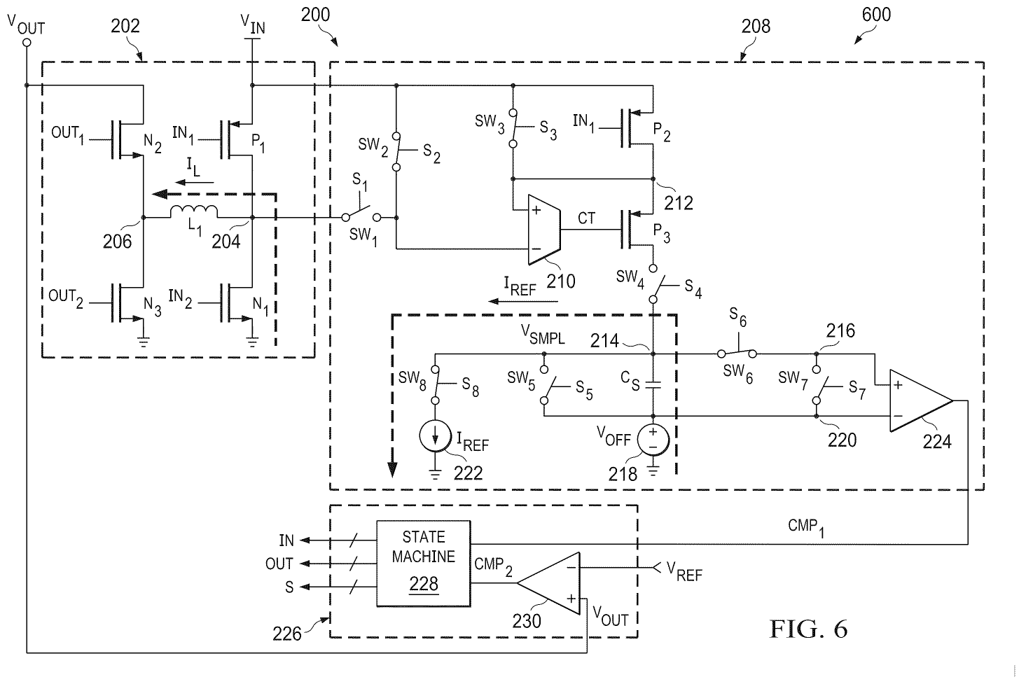

Operation of the power supply circuit 200 is shown in greater detail in FIGS. 4-6. FIG. 4 is another example of timing diagrams. The timing diagrams include a first timing diagram 402 that shows inductor current I_{L} plotted as a function of time for a converter operating in buck mode. The first timing diagram 402 is therefore the same as the first timing diagram 302 in the example of FIG. 3. A second timing diagram 404 is the sampling voltage V_{SMPL} plotted as a function of time. FIG. 5 is an example of a schematic electrical circuit diagram 500 of current flow in in the power supply circuit 200 in the first switching phase of the switching voltage regulator 202, and FIG. 6 is an example of a schematic electrical circuit diagram 600 of current flow in in the power supply circuit 200 in the second switching phase of the switching voltage regulator 202. Accordingly, reference is to be made to the examples of FIGS. 4-6 in the following description.

In the first timing diagram 402, the switching voltage regulator 202 begins the first switching phase at a time T₀. At the time T₀, the PFET P₁ and the NFET N₃ are activated by the switching signals IN₁ and OUT₂, respectively. Additionally, with reference to the example of FIG. 5, the switches SW₁, SW₄, SW₇, and SW₈ are closed by the switching signals S₁, S₄, S₇, and S₈, respectively. Therefore, the input current I_{IN} flows from the input voltage V_{IN}, through the PFET P₁, and through the inductor L₁ as the current I_{L}, and through the NFET N₃. Thus, in the example of FIG. 4, the current I_{L}, is demonstrated as increasing from an amplitude of I_{L0} to an amplitude I_{L1}.

At the time T₁, the NFET N₃ is deactivated by the switching signal OUT₂ and the NFET N₂ is activated by the switching signal OUT₁. Therefore, the input current I_{IN} flows from the input voltage V_{IN}, through the PFET P₁, and through the inductor L₁ as the current I_{L}, and through the NFET N₂. Thus, the current I_{L} continues to increase in amplitude from the time T₁ to the time T₂ during the first switching phase of the switching voltage regulator 202. Additionally, with further reference to the example of FIG. 5, during the first switching phase defined between the times T₀ and T₂, the input current I_{IN} is emulated by the charging current I_{CH} through the replica PFET P₂, based on the matched PFETs P₁ and P₂ concurrently activated by the switching signal IN₁, with the charging current I_{CH} having a scaled amplitude approximately equal to the amplitude of the input current I_{IN} divided by the channel-width scale factor K (e.g., I_{CH}=I_{IN}/K).

Because of the closure of the switch SW₁, the transconductance amplifier 210 receives an approximately equal voltage at each of the inputs at the switching node 204 and the node 212 due to the high gain of transconductance amplifier 210. The transconductance amplifier 210 can be configured as a high bandwidth transconductance amplifier 210 to track the slope of the current I_{L}. (e.g., the input current I_{IN} during the first switching phase of the switching voltage regulator 202), and can be configured with low offset to measure the current I_{L} as absolute, as opposed to relative. Low offset can be implemented, for example, by providing trimming, calibrating, or chopping of the transconductance amplifier 210, or providing auto-zero techniques using switches SW₂ and SW₃, as described in greater detail herein.

The transconductance amplifier 210 provides a control signal CT to the PFET P₃ to conduct the charging current I_{CH} through the PFET P₃ and through the switch SW₄ to the sampling node 214. While the charging current I_{CH} is provided to the sampling node 214, based on the closure of the switch SW₈, the reference current I_{REF} flows from the sampling node 214. As a result, a sampling current I_{SMPL} is provided through the sampling capacitor C_{S}. The current I_{SMPL} therefore has an amplitude that is equal to the charging current I_{CH} minus the reference current I_{REF}. Thus, the sampling current I_{SMPL} begins charging the sampling capacitor C_{S} to increase the amplitude of the sampling voltage V_{SMPL}. Because the switch SW₆ is open and the switch SW₇ is closed during the first switching phase of the switching voltage regulator 202, the sampling comparator 224 is not monitoring the sampling voltage V_{SMPL}. Therefore, the first comparison signal CMP₁ is asserted at a logic-high state.

Referring back to the example of FIG. 4, the switching voltage regulator 202 switches from the first switching phase to the second switching phase at the time T₂. At the time T₂, the PFET P₁ is deactivated and the NFET N₁ is activated by the switching signals IN₁ and IN₂, respectively, and the NFET N₂ remains activated. Additionally, with reference to the example of FIG. 6, the switches SW₁, SW₄, and SW₇ are opened by the switching signals S₁, S₄, and S₇, respectively, and the switches SW₂, SW₃, and SW₆ are closed by the switching signals S₂, S₃, and S₆, respectively. The switch SW₈ remains closed during the second switching phase of the switching voltage regulator 202. Therefore, the input current I_{IN} ceases, and the current I_{L} flows from the low-voltage rail, through the NFET N₁, through the inductor L₁, and through the NFET N₂. Thus, in the example of FIG. 4, the current I_{L} is demonstrated as decreasing from the amplitude I_{L2} to an amplitude I_{L3} at a time T₃. At the time T₃, the NFET N₂ is deactivated by the switching signal OUT₁ and the NFET N₃ is activated by the switching signal OUT₂. Therefore, the current I_{L} flows from the low-voltage rail, through the NFET N₁, through the inductor L₁, and through the NFET N₃. Thus, in the example of FIG. 4, the current I_{L} is demonstrated as decreasing from the amplitude I_{L3} to the initial amplitude I_{L0} at a time T₄.

With reference to the example of FIG. 6, in the second switching phase of the switching voltage regulator 202, the PFETs P₁ and P₂ are both deactivated, which ceases the flow of the input current I_{IN}, and by extension, the charging current I_{CH}. The switches SW₂ and SW₃ are closed to provide zeroing of the transconductance amplifier 210. Because the charging current I_{CH} ceases to flow, the charging current I_{CH} is no longer provided to the sampling node 214. However, the switch SW₈ is still closed in the second switching phase of the switching voltage regulator 202, resulting in the reference current I_{REF} continuing to draw charge from the sampling capacitor C_{S}. As a result, the sampling voltage V_{SMPL} decreases beginning at the time T₂ during the second switching phase of the switching voltage regulator 202.

Due to the closure of the switch SW₆, the sampling comparator 224 compares the sampling voltage V_{SMPL} at the sampling node 214 with the voltage at the node 220, and therefore monitors the voltage across the sampling capacitor C_{S}. Responsive to the sampling voltage V_{SMPL} having an amplitude of approximately zero, and thus the sampling capacitor C_{S} has approximately zero charge, the sampling comparator 224 can de-assert the first comparison signal CMP₁. As described herein, a zero amplitude of the sampling voltage V_{SMPL} refers to an approximately zero amplitude across the sampling capacitor C_{S}, based on the sampling voltage V_{SMPL} being referenced to the offset voltage V_{OFF} at the node 220. The zero amplitude of the sampling voltage V_{SMPL} can also refer to an approximately negative amplitude of the sampling voltage V_{SMPL} based on the sampling capacitor C_{S}, such that the inverting input of the sampling comparator 224 has a greater voltage amplitude than the sampling voltage V_{SMPL} at the non-inverting input of the sampling comparator 224.

Responsive to the de-assertion of the first comparison signal CMP₁, and responsive to a logic-low amplitude of the second comparison signal CMP₂ as provided by the reference comparator 230 (e.g., responsive to the reference voltage V_{REF} being greater than the output voltage VOLT), the state machine 228 can change the state of the switching signals IN, OUT, and S. Therefore, the state machine 228 can switch the switching voltage regulator 202 from the second switching phase to the first switching phase, and thus the beginning of a next switching period. Therefore, the state machine 228 can dictate the time duration of the switching periods of the switching voltage regulator 202 based on the amplitude of the input current I_{IN} relative to the reference current I_{REF} (e.g., based on the sampling voltage V_{SMPL}) to regulate the amplitude of the input current I_{IN}.

As an example, upon completion of a switching period, the state machine 228 implements an idle (e.g., sleep) mode for the power supply circuit 200, such as based on a deactivation mode for the power supply circuit 200 or for a discontinuous mode of operation for the switching voltage regulator 202. For example, during an idle mode, the switch SW₈ is opened by the switching signal S& to disconnect the reference voltage I_{REF} from the sampling capacitor C_{S}. Additionally, the switches SW₂ and SW₃ can remain closed to provide zeroing of the transconductance amplifier 210, the switch SW₈ can be closed by the switching signal S₅ to provide zeroing of the sampling capacitor C_{S}, and the switch SW₆ can remain closed to latch the first comparison signal CMP₁ provided by the sampling comparator 224. The state machine 228 therefore can await a change in state of the second comparison signal CMP₂ to begin a next switching period.

Because the power supply circuit 200 provides switching times based on the amplitude of the input current I_{IN} relative to the reference current I_{REF} (e.g., based on the sampling voltage V_{SMPL}), the power supply circuit 200 can regulate the amplitude of the input current lix in a manner that is more effective than input current regulation in a typical power supply circuit. For example, as described above, the current regulation of the power supply circuit 200 is implemented for more complex waveforms of the inductor current I_{L}, as well as non-zero initial amplitudes of the inductor current I_{L}, as opposed to being limited to triangular inductor current waveforms with an initial zero amplitude, as is the case for a typical power supply circuit. Additionally, the power supply circuit 200 provides real-time measurement of the input current I_{IN} during each cycle of the switching voltage regulator 202, and thus an actual peak amplitude of the inductor current I_{L}, as opposed to regulating the input current based on a fixed peak current amplitude estimate as is provided in a typical power supply circuit. Furthermore, a typical power supply circuit requires multiple capacitors for comparing multiple charges (e.g., a charge transmitted from the input and a charge of a desired average input current) to perform input current regulation. The power supply circuit 200 includes only a single capacitor for current regulation (e.g., the sampling capacitor C_{S}), which can provide for a more compact circuit and remove the requirement for matching between two or more capacitors. Accordingly, the input current regulation provided by the power supply circuit 200 can be substantially more effective than input current regulation of a typical power supply circuit.

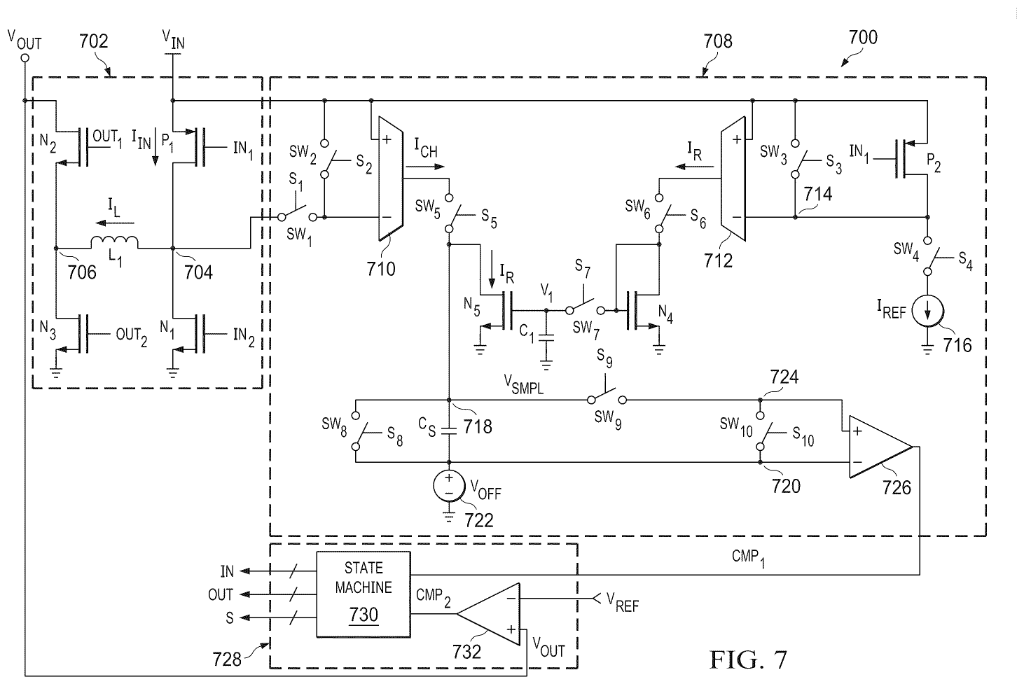

FIG. 7 is another example of a schematic electrical circuit diagram of a power supply circuit 700. The power supply circuit 700 can be implemented in any of a variety of wireless electronic devices, such as laptop computers, tablet computers, smart phones, or any of a variety of other electronic devices. The power supply circuit 700 is configured to generate an output voltage V_{OUT} from an input voltage V_{IN}. The power supply circuit 700 can be the power supply system 100 in the example of FIG. 1. Therefore, the description of the example of FIG. 7 also refers to FIG. 1. The power supply circuit 700 in the example of FIG. 7 is provided as another example of the current regulation technique that implements an open-loop topology for a transconductance amplifier (as described in greater detail herein), as opposed to the closed-loop topology for the transconductance amplifier 210 in the example of FIG. 2. Therefore, the power supply circuit 700 need not require stability compensation resulting in support of a high slope of the inductor current I_{L} based on a smaller inductance of the inductor L₁.

The power supply circuit 700 includes a switching voltage regulator 702. The switching voltage regulator 702 includes a high-side switch, shown as a PFET P₁, a low-side switch, shown as an NFET N₁, a first output switch, shown as an NFET N₂, and a second output switch, shown as an NFET N₃. The PFET P₁ interconnects the input voltage V_{IN} at a source and a switching node 704 at a drain, and the NFET N₁ interconnects the switching node 704 at a drain and a low-voltage rail, shown in the example of FIG. 7 as ground, at a source. The NFET N₂ interconnects the output voltage V_{OUT} at a drain and a switching node 706 at a source, and the NFET N₃ interconnects the switching node 706 at a drain and the low-voltage rail at a source. An inductor L₁ interconnects the switching nodes 704 and 706 and is configured to conduct a current I_{L}.

The PFET P₁ is controlled by a switching signal IN₁, the NFET N₁ is controlled by a switching signal IN₂, the NFET N₂ is controlled by a switching signal OUT₁, and the NFET N₃ is controlled by a switching signal OUT₂. The activation of the FETs P₁, N₁, N₂, and N₃ in a sequence provides the current I_{L} through the inductor L₁ in switching phases defined by the switching signals IN₁, IN₂, OUT₁, and OUT₂, respectively. For example, the activation of the PFET P₁ provides the input current I_{IN} to flow from the input voltage V_{IN} to the switching node 704 during the first switching phase based on the switching signal IN₁, such that the current I_{L} is approximately equal to the input current I_{IN} during the first switching phase of the switching voltage regulator 702. During the second switching phase of the switching voltage regulator 702, the PFET P₁ is deactivated and the NFET N₁ is activated by the switching signal IN₂ to conduct the current I_{L} from the low-voltage rail through the inductor L₁. Therefore, the switching voltage regulator 702 operates substantially the same as the switching voltage regulator 202 in the example of FIG. 2.

The power supply circuit 700 also includes a current regulator system 708 that is configured to regulate an amplitude of the input current I_{IN}. In the example of FIG. 7, the current regulator system 708 includes a first transconductance amplifier 710 that has a first input that is coupled to the switching node 704 through a first switch SW₁ controlled by a switching signal S₁ and to the input voltage V_{IN} through a second switch SW₂ controlled by a switching signal S₂. The first transconductance amplifier 710 also has a second input that is coupled to the input voltage V_{IN}. The current regulator system 708 also includes a second transconductance amplifier 712 that has a first input that is coupled to a node 714 and to the input voltage V_{IN} through a switch SW₃ controlled by a switching signal S₃. The first and second transconductance amplifiers 710 and 712 can be fabricated approximately identically, and can therefore have an approximately equal transconductance (GM) factor. The second transconductance amplifier 712 also has a second input that is coupled to the input voltage V_{IN}. The node 714 is coupled to the input voltage V_{IN} through a PFET P₂. As an example, the PFET P₂ is a replica switch with respect to the PFET P₁, such that the PFET P₂ has a channel width that is scaled-down by a factor of K relative to the PFET P₁.

In the example of FIG. 7, the PFET P₂ is activated by the switching signal IN₁, such that the PFET P₂ is activated concurrently with the PFET P₁ to conduct the reference current I_{REF} that is generated from a current source 716 through a switch SW₄ that is controlled by a switching signal S₄. The current source 716 can be the reference current generator 108 in the example of FIG. 1. For example, the current source 716 is provided at an external pin of the associated IC on which the power supply circuit 700 is fabricated (e.g., as a grounded resistor). Therefore, when the switch SW₄ is closed, the current source 716 is configured to conduct the reference current I_{REF} from the input voltage V_{IN} and through the PFET P₂. As described above, the reference current I_{REF} has an amplitude that is proportional to a maximum average amplitude setpoint of the input current I_{IN} of the switching voltage regulator 702. For example, the proportionality of the reference current I_{REF} to the maximum average amplitude setpoint of the input current I_{IN} (expressed as I_{TAR}) is likewise scaled by the factor of K, as provided above in Equation 1.

The first transconductance amplifier 710 is configured to generate a charging current I_{CH} that is provided to a sampling node 718 through a switch SW₈ controlled by a switching signal S₅. For example, the charging current I_{CH} has an amplitude that is expressed as follows:

$${I}_{CH} = GM * {I}_{IN} * {R}_{DSON} \qquad Equation 2$$

Where: GM is the transconductance of the first transconductance amplifier 710; R_{DSON} is the activation resistance of the PFET P₁.

Additionally, the second transconductance amplifier 712 is configured to generate a current I_{R} that is provided through a switch SW₆ that is controlled by a switching signal S₆ and through a diode-connected NFET N₄. As an example, in the example of FIG. 7, the current I_{R} has an amplitude that is expressed as follows:

$${I}_{R} = GM * {I}_{TAR} * K * {R}_{DSON} \qquad Equation 3$$

Where: GM is the transconductance of the second transconductance amplifier 712, which is approximately equal to the transconductance of the first transconductance amplifier 710;
   K*R_{DSON} is the activation resistance of the PFET P₂, which is approximately equal to K-times the activation resistance of the PFET P₁.

The diode-connected NFET N₄ has a gate and drain that are coupled to a sample and hold capacitor C₁ and a gate of an NFET N₅ through a switch SW₇ that is controlled by a switching signal S₇. Therefore, the NFETs N₄ and N₅ are arranged as a current mirror, with the current I_{R} being provided to the capacitor C₁ when the switch SW₇ is closed to charge the capacitor C₁. The voltage V₁ on the capacitor C₁ thus provides an activation voltage for the NFET N₅ to mirror the current I_{R} through the NFET N₅. Therefore, the NFET N₅ likewise conducts the current I_{R}.

Similar to the power supply circuit 200, the sampling node 718 is coupled to a sampling capacitor C_{S} and has a sampling voltage V_{SMPL}. The sampling capacitor C_{S} interconnects the sampling node 718 and a node 720. The sampling node 718 and the node 720 are also coupled by a switch SW₈ that is controlled by a switching signal S₈. A voltage source 722 provides an offset voltage V_{OFF} to the node 720. Additionally, a switch SW₉ that is controlled by a switching signal S₉ interconnects the sampling node 718 and a node 724, and a switch SW₁₀ that is controlled by a switching signal S₁₀ interconnects the nodes 720 and 724. In the example of FIG. 7, the NFET N₅ is coupled to the sampling node 718 at a drain. Therefore, the NFET N₅ is configured to conduct the current I_{R} from the sampling node 718, and thus from the sampling capacitor C_{S}. For example, the offset voltage V_{OFF} (e.g., approximately 350 mV) provides sufficient headroom for the current I_{R}.

The current regulator system 708 includes a sampling comparator 726 that has inputs at the nodes 724 and 720. Therefore, the sampling comparator 726 is configured to monitor the sampling voltage V_{SMPL} on the sampling capacitor C_{S} when the switch SW₉ is closed (e.g., based on common mode operation defined by the offset voltage V_{OFF}). The sampling comparator 726 can generate a first comparison signal CMP₁ responsive to determining that the sampling voltage V_{SMPL} has an amplitude of approximately zero.

The power supply circuit 700 further includes a switch controller 728 that includes a state machine 730. The first comparison signal CMP₁ is provided to the state machine 730 that also receives a second comparison signal CMP₂ from a reference comparator 732. In the example of FIG. 7, the reference comparator 732 is configured to compare the output voltage V_{OUT} with a fixed reference voltage V_{REF}. Based on the comparison signals CMP₁ and CMP₂, the state machine 730 can generate the switching signals IN, OUT, and S that are provided to the respective PFETs P₁ through P₃, the NFETs N₁ through N₃, and the switches SW₁ through SW₁₀, respectively. Therefore, the state machine 730 can define the first and second switching phases of the switching voltage regulator 702, and therefore the switching period of the switching voltage regulator 702. The state machine 730 can also provide the controls for operating the switches SW₁ through SW₁₀ to provide the operation of the current regulator system 708 in each of the first and second switching phases to regulate the amplitude of the input current I_{IN}.

The power supply circuit 700 is not limited to the example shown in FIG. 7. For example, the switching voltage regulator 702 is not limited to the arrangement of the high and low-side switches P₁, N₁, N₂, and N₃. As one example, the PFET P₁, and by extension the replica PFET P₂, is arranged as N-channel transistors instead.

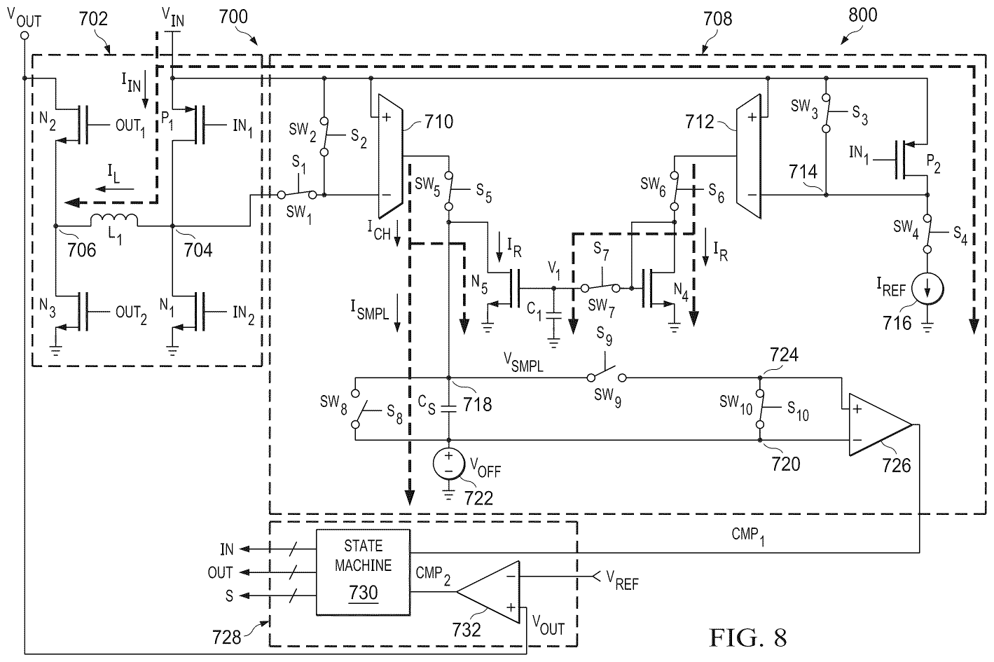

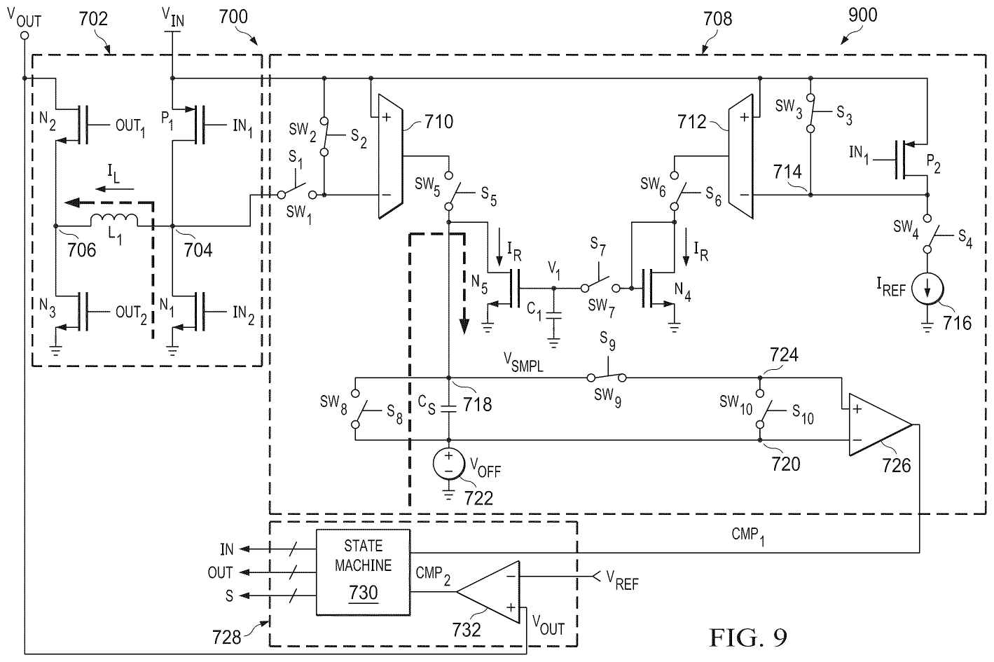

Operation of the power supply circuit 700 is shown in greater detail in FIGS. 4, 8, and 9. FIG. 8 is another example of a schematic electrical circuit diagram 800 of current flow in the power supply circuit 700 in the first switching phase of the switching voltage regulator 702, and FIG. 9 is another example of a schematic electrical circuit diagram 900 of current flow in the power supply circuit 700 in the second switching phase of the switching voltage regulator 702. Accordingly, the following description also refers to the examples of FIGS. 4, 8, and 9.

In the first timing diagram 402, the switching voltage regulator 702 begins the first switching phase at a time T₀. At the time T₀, the PFET P₁ and the NFET N₃ are activated by the switching signals IN₁ and OUT₂, respectively. Additionally, with reference to the example of FIG. 8, the switches SW₁, SW₄, SW₅, SW₆, SW₇, and SW₁₀ are closed by the switching signals S₁, S₄, S₅, S₆, S₇, and S₁₀, respectively. Therefore, the input current I_{IN} flows from the input voltage V_{IN}, through the PFET P₁, and through the inductor L₁ as the current I_{L}, and through the NFET N₃. Thus, in the example of FIG. 4, the current I_{L} is demonstrated as increasing from an amplitude I_{L0} to an amplitude I_{L1}.

At the time T₁, the NFET N₃ is deactivated by the switching signal OUT₂ and the NFET N₂ is activated by the switching signal OUT₁. Therefore, the input current I_{IN} flows from the input voltage V_{IN}, through the PFET P₁, and through the inductor L₁ as the current I_{L}, and through the NFET N₂. Thus, the current I_{L} continues to increase in amplitude from the time T₁ to the time T₂ during the first switching phase of the switching voltage regulator 702. Additionally, with further reference to the example of FIG. 8, during the first switching phase defined between the times T₀ and T₂, the input current I_{IN} flows through the PFET P₁ and the reference current flows through the PFET P₂ based on the matched PFETs P₁ and P₂ concurrently activated by the switching signal IN₁. The first transconductance amplifier 710 generates the charging current I_{CH} based on the input current I_{IN} and having an amplitude defined by Equation 2 above based on the closure of the switch SW₁. Similarly, the second transconductance amplifier 712 generates the current I_{R} based on the reference current and having an amplitude defined by Equation 3 above based on the closure of the switch SW₄.

Based on the closure of the switch SW₅, the charging current I_{CH} is provided from the first transconductance amplifier 710 to the sampling node 718. Based on the closure of the switch SW₆, the current I_{R} is provided from the second transconductance amplifier 712 through the NFET N₄. The current I_{R} charges the capacitor C₁ to provide the voltage V₁ at the gate of the NFET N₅, and the current I_{R} is mirrored from the NFET N₄ to the NFET N₅. As a result, a sampling current I_{SMPL} is provided through the sampling capacitor C_{S}. The current I_{SMPL} therefore has an amplitude that is equal to the charging current I_{CH} minus the current I_{R}. Thus, the sampling current I_{SMPL} begins charging the sampling capacitor C_{S} to increase the amplitude of the sampling voltage V_{SMPL}. Because the switch SW is open and the switch SW₁₀ is closed during the first switching phase of the switching voltage regulator 702, the sampling comparator 726 is not monitoring the sampling voltage V_{SMPL}. Therefore, the first comparison signal CMP₁ is asserted at a logic-high state.

Referring back to the example of FIG. 4, the switching voltage regulator 702 switches from the first switching phase to the second switching phase at the time T₂. At the time T₂, the PFET P₁ is deactivated and the NFET N₁ is activated by the switching signals IN₁ and IN₂, respectively, and the NFET N₂ remains activated. Additionally, with reference to the example of FIG. 9, the switches SW₁, SW₄, SW₅, SW₆, SW₇, and SW₁₀ are opened by the switching signals S₁, S₄, S₅, S₆, S₇, and S₁₀, respectively, and the switches SW₂, SW₃, and SW₉ are closed by the switching signals S₂, S₃, and S₉, respectively. Therefore, the input current I_{IN} ceases, and the current I_{L} flows from the low-voltage rail, through the NFET N₁, through the inductor L₁, and through the NFET N₂. Thus, in the example of FIG. 4, the current I_{L} is demonstrated as decreasing from the amplitude I_{L2} to an amplitude I_{L3} at a time T₃. At the time T₃, the NFET N₂ is deactivated by the switching signal OUT₁ and the NFET N₃ is activated by the switching signal OUT₂. Therefore, the current I_{L} flows from the low-voltage rail, through the NFET N₁, through the inductor L₁, and through the NFET N₃. Thus, in the example of FIG. 4, the current I_{L} is demonstrated as decreasing from the amplitude I_{L3} to the initial I_{L0} at a time T₄.

With reference to the example of FIG. 9, in the second switching phase of the switching voltage regulator 702, the PFETs P₁ and P₂ are both deactivated, which ceases the flow of the input current I_{IN}, and by extension, the reference current I_{REF}. The switches SW₂ and SW₃ are closed to provide zeroing of the first and second transconductance amplifiers 710 and 712. Because the charging current I_{CH} ceases to flow from the first transconductance amplifier 710, the charging current I_{CH} is no longer provided to the sampling node 718. Similarly, the current I_{R} ceases to flow from the second transconductance amplifier 712. However, the sampled voltage V₁ across the capacitor C₁ continues to provide activation of the NFET N₅ in the second switching phase of the switching voltage regulator 702, resulting in the current I_{R} continuing to draw charge from the sampling capacitor C_{S}. As a result, the sampling voltage V_{SMPL} decreases beginning at the time T₂ during the second switching phase of the switching voltage regulator 702.

Due to the closure of the switch SW₉, the sampling comparator 726 compares the sampling voltage V_{SMPL} at the sampling node 718 with the voltage at the node 720, and therefore monitors the voltage across the sampling capacitor C_{S}. Responsive to the sampling voltage V_{SMPL} having an amplitude of approximately zero, and thus the sampling capacitor C_{S} has approximately zero charge, the sampling comparator 726 can de-assert the first comparison signal CMP₁. Responsive to the de-assertion of the first comparison signal CMP₁, and responsive to a logic-low amplitude of the second comparison signal CMP₂ as provided by the reference comparator 732 (e.g., responsive to the reference voltage V_{REF} being greater than the output voltage VOLT), the state machine 730 can change the state of the switching signals IN, OUT, and S. Therefore, the state machine 730 can switch the switching voltage regulator 702 from the second switching phase to the first switching phase, and thus the beginning of a next switching period. Therefore, the state machine 730 can dictate the time duration of the switching periods of the switching voltage regulator 702 based on the amplitude of the input current I_{IN} relative to the reference current I_{REF} (e.g., based on the sampling voltage V_{SMPL}) to regulate the amplitude of the input current I_{IN}.

Similar to as described above, upon completion of a switching period, the state machine 730 can implement an idle (e.g., sleep) mode for the power supply circuit 700, such as based on a deactivation mode for the power supply circuit 700 or for a discontinuous mode of operation for the switching voltage regulator 702. For example, during an idle mode, the switches SW₂ and SW₃ remains closed to provide zeroing of the transconductance amplifiers 710 and 712, the switch SW₈ is closed by the switching signal S& to provide zeroing of the sampling capacitor C_{S}, and the switch SW₉ remains closed to provide zeroing of the sampling comparator 726. The state machine 730 therefore can await a change in state of the second comparison signal CMP₂ to begin a next switching period.

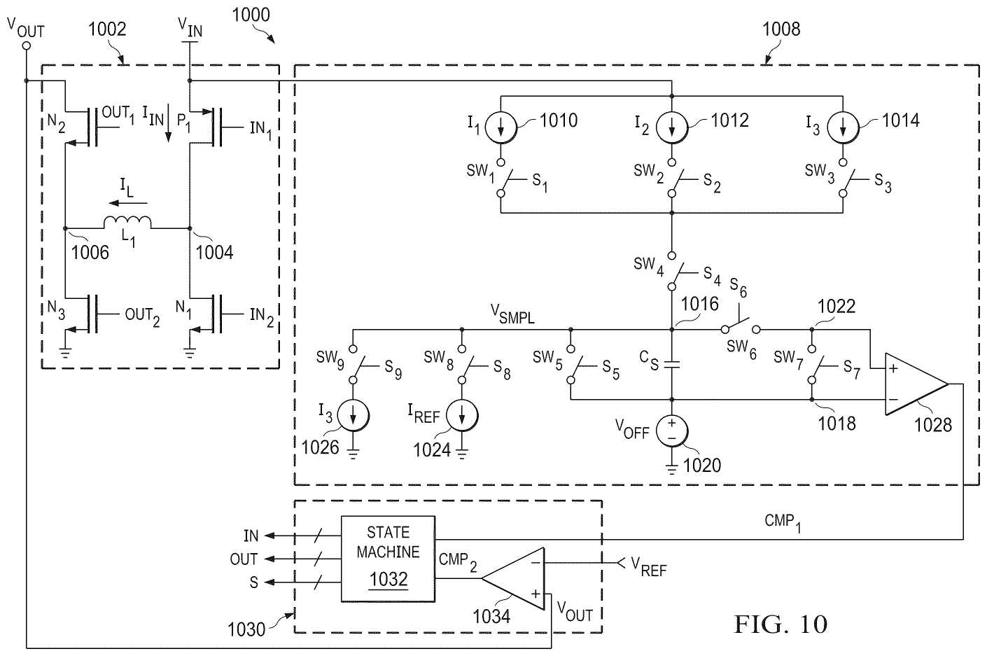

FIG. 10 is another example of a schematic electrical circuit diagram showing current flow in a power supply circuit 1000. The power supply circuit 1000 can be implemented in any of a variety of wireless electronic devices, such as laptop computers, tablet computers, smart phones, or any of a variety of other electronic devices. The power supply circuit 1000 is configured to generate an output voltage V_{OUT} from an input voltage V_{IN}. The power supply circuit 1000 can be the power supply system 100 in the example of FIG. 1. Therefore, the description of FIG. 10 also refers to FIG. 1. The power supply circuit 1000 in the example of FIG. 10 provides another example of the current regulation technique that implements estimated values for the peak and valley amplitudes of the inductor current I_{L}. For example, the estimates for the peak and valley amplitudes of the inductor current I_{L} is calculated in any of a variety of ways, such as the operating modes of the power supply circuit 1000, the relative amplitudes of the input voltage V_{IN} and the output voltage VOLT, duty-cycles, factory testing/calibration, or any of a variety of methods.

The power supply circuit 1000 includes a switching voltage regulator 1002. The switching voltage regulator 1002 includes a high-side switch, shown as a PFET P₁, a low-side switch, shown as an NFET N₁, a first output switch, shown as an NFET N₂, and a second output switch, shown as an NFET N₃. The PFET P₁ interconnects the input voltage V_{IN} at a source and a switching node 1004 at a drain, and the NFET N₁ interconnects the switching node 1004 at a drain and a low-voltage rail, shown in the example of FIG. 10 as ground, at a source. The NFET N₂ interconnects the output voltage V_{OUT} at a drain and a switching node 1006 at a source, and the NFET N₃ interconnects the switching node 1006 at a drain and the low-voltage rail at a source. An inductor L₁ interconnects the switching nodes 1004 and 1006 and is configured to conduct a current I_{L}.

The PFET P₁ is controlled by a switching signal IN₁, the NFET N₁ is controlled by a switching signal IN₂, the NFET N₂ is controlled by a switching signal OUT₁, and the NFET N₃ is controlled by a switching signal OUT₂. The activation of the FETs P₁, N₁, N₂, and N₃ in a sequence provides the current I_{L} through the inductor L₁ in switching phases defined by the switching signals IN₁, IN₂, OUT₁, and OUT₂, respectively. For example, the activation of the PFET P₁ provides the input current I_{IN} to flow from the input voltage V_{IN} to the switching node 1004 during the first switching phase based on the switching signal IN₁, such that the current I_{L} is approximately equal to the input current lix during the first switching phase of the switching voltage regulator 1002. During the second switching phase of the switching voltage regulator 1002, the PFET P₁ is deactivated and the NFET N₁ is activated by the switching signal IN₂ to conduct the current I_{L} from the low-voltage rail through the inductor L₁. Therefore, the switching voltage regulator 1002 operates substantially the same as the switching voltage regulator 202 in the example of FIG. 2.

The power supply circuit 1000 also includes a current regulator system 1008 that is configured to regulate an amplitude of the input current I_{IN}. In the example of FIG. 10, the current regulator system 1008 includes a first current source 1010 that generates a first current I_{L} a second current source 1012 that generates a second current I₂, and a third current source 1014 that generates a third current I₃. As an example, the currents I₁, I₂, and I₃, in combination, are the charging current I_{CH} during the first switching phase, as described in greater detail herein. The first current source 1010 interconnects the input voltage V_{IN} and a switch SW₁ that is controlled by a switching signal S₁, the second current source 1012 interconnects the input voltage V_{IN} and a switch SW₂ that is controlled by a switching signal S₂, and the third current source 1014 interconnects the input voltage V_{IN} and a switch SW₃ that is controlled by a first switching signal S₃. The parallel arrangements of the current source 1010 and the switch SW₁, the current source 1012 and the switch SW₂, and the current source 1014 and the switch SW₃ are arranged in series with a switch SW₄ that is controlled by a switching signal S₄.

The switch SW₄ is coupled to a sampling node 1016. A sampling capacitor C_{S} interconnects the sampling node 1016 and a node 1018. The sampling node 1016 and the node 1018 are also coupled by a switch SW₅ that is controlled by a switching signal S₅. A voltage source 1020 provides an offset voltage V_{OFF} to the node 1018. Additionally, a switch SW₆ that is controlled by a switching signal S₆ interconnects the sampling node 1016 and a node 1022, and a switch SW₇ that is controlled by a switching signal S₇ interconnects the nodes 1018 and 1022.

The current regulator system 1008 also includes a current source 1024 that is coupled to the sampling node 1016 through a switch SW₈ that is controlled by a switching signal S₈. The current source 1024 can be the reference current generator 108 in the example of FIG. 1. For example, the current source 1024 is provided at an external pin of the associated IC on which the power supply circuit 1000 is fabricated (e.g., as a grounded resistor). Therefore, when the switch SW₈ is closed, the current source 1024 is configured to conduct the reference current I_{REF} from the sampling node 1016, and thus from the sampling capacitor C_{S}. For example, the offset voltage V_{OFF} (e.g., approximately 350 mV) provides sufficient headroom for the reference current I_{REF}. As described above, the reference current I_{REF} can have an amplitude that is proportional to a maximum average amplitude setpoint of the input current I_{IN} of the switching voltage regulator 1002. For example, the proportionality of the reference current I_{REF} to the maximum average amplitude setpoint of the input current I_{IN} (expressed as I_{TAR}) is likewise scaled by the factor of K, as provided above in Equation 1. In addition, the current regulator system 1008 includes a current source 1026 that is coupled to the sampling node 1016 through a switch SW₉ that is controlled by a switching signal S₉. The current source 1026 generates the current I₃, which is approximately equal to the current I₃ generated by the current source 1014 described above.

The switching voltage regulator 1008 includes a sampling comparator 1028 that has inputs at the nodes 1018 and 1022. The sampling comparator 1028 is therefore configured to monitor the sampling voltage V_{SMPL} on the sampling capacitor C_{S} when the switch SW₆ is closed (e.g., based on common mode operation defined by the offset voltage V_{OFF}). The sampling comparator 1028 can generate a first comparison signal CMP₁ responsive to determining that the sampling voltage V_{SMPL} has an amplitude of approximately zero.

The power supply circuit 1000 further includes a switch controller 1030 that includes a state machine 1032. The first comparison signal CMP₁ is provided to the state machine 1032 that also receives a second comparison signal CMP₂ from a reference comparator 1034. In the example of FIG. 10, the reference comparator 1034 is configured to compare the output voltage V_{OUT} with a fixed reference voltage V_{REF}. Based on the comparison signals CMP₁ and CMP₂, the state machine 1032 can generate the switching signals IN, OUT, and S that are provided to the respective PFET P₁, the NFETs N₁ through N₃, and the switches SW₁ through SW₉, respectively. Therefore, the state machine 1032 can define the first and second switching phases of the switching voltage regulator 1002, and therefore the switching period of the switching voltage regulator 1002. The state machine 1032 can also provide the controls for operating the switches SW₁ through SW₉ to provide the operation of the current regulator system 1008 in each of the first and second switching phases to regulate the amplitude of the input current I_{IN}.

The power supply circuit 1000 is not limited to the circuit shown FIG. 10. For example, the switching voltage regulator 1002 is not limited to the arrangement of the high and low-side switches P₁, N₁, N₂, and N₃. As one example, the PFET P₁ is arranged as an N-channel transistor instead.

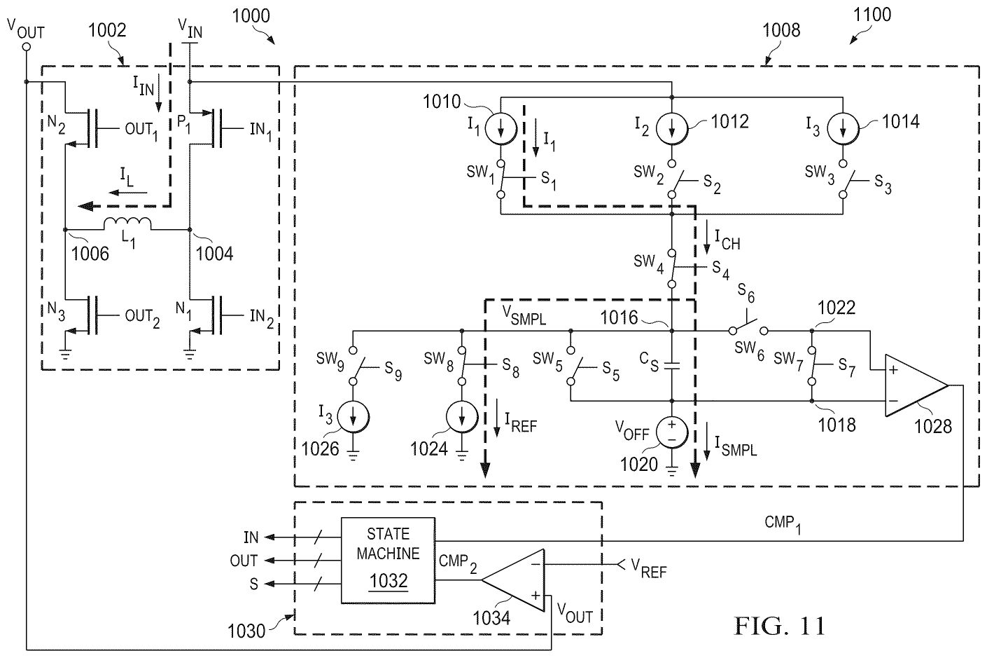

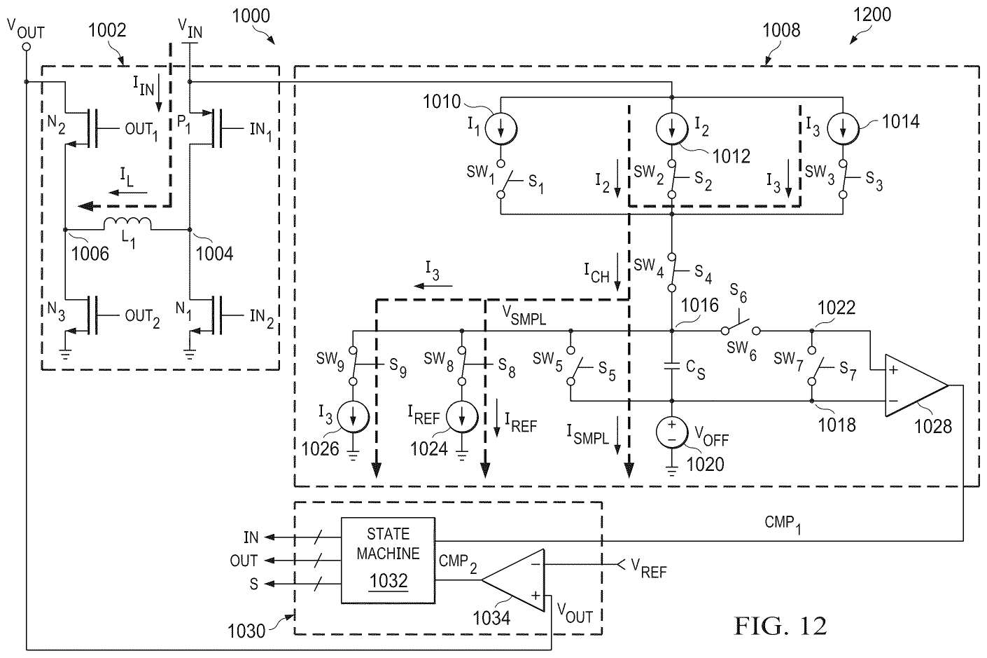

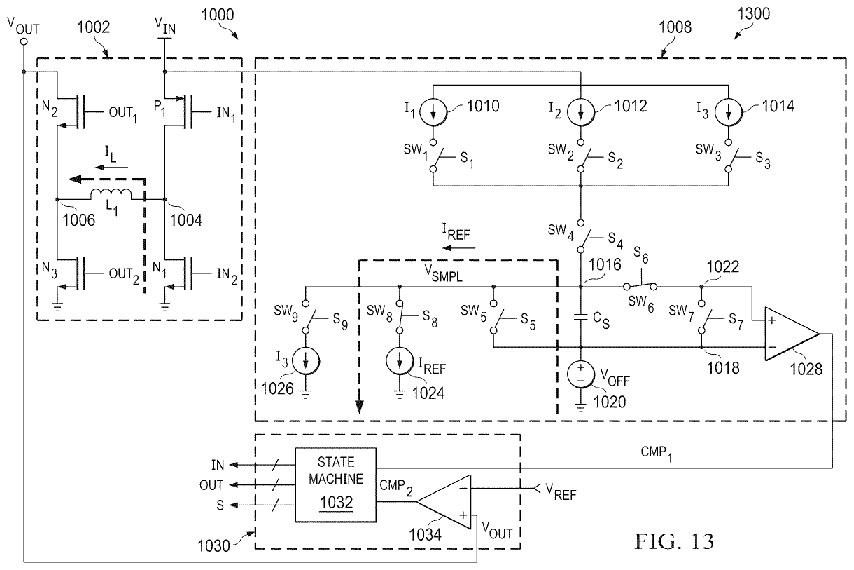

Operation of the power supply circuit 1000 is shown in greater detail in FIGS. 4 and 11-13. FIG. 11 is another example of a schematic electrical circuit diagram 1100 of current flow in the power supply circuit 1000 in the first switching phase of the switching voltage regulator 1002, FIG. 12 is another example of a schematic electrical circuit diagram 1200 of current flow in the power supply circuit 1000 in the first switching phase of the switching voltage regulator 1002, and FIG. 13 is another example of a schematic electrical circuit diagram 1300 of current flow in the power supply circuit 1000 in the second switching phase of the switching voltage regulator 1002. Accordingly, the description of FIG. 11 also refers to the examples of FIGS. 4 and 11-13.

In the first timing diagram 402, the switching voltage regulator 1002 begins the first switching phase at a time T₀. At the time T₀, the PFET P₁ and the NFET N₃ are activated by the switching signals IN₁ and OUT₂, respectively. Therefore, the input current I_{IN} flows from the input voltage V_{IN}, through the PFET P₁, and through the inductor L₁ as the current I_{L}, and through the NFET N₃. Thus, in the example of FIG. 4, the current I_{L} is demonstrated as increasing from an amplitude of I_{L0} to an amplitude I_{L1}.

Additionally, with reference to the example of FIG. 11, the switches SW₁, SW₄, SW₇, and SW₈ are closed by the switching signals S₁, S₄, S₇, and S₈, respectively, from the time T₀ to the time T₁. Therefore, from the time T₀ and T₁, the current I₁ flows from the current source 1010, through the closed switches SW₁ and SW₄, and to the sampling node 1016. While the current I₁ is provided to the sampling node 1016, based on the closure of the switch SW₈, the reference current I_{REF} flows from the sampling node 1016. As a result, a sampling current I_{SMPL} is provided through the sampling capacitor C_{S}. The current I_{SMPL} therefore has an amplitude that is equal to the current I₁ minus the reference current I_{REF}. Thus, the sampling current I_{SMPL} begins charging the sampling capacitor C_{S} to increase the amplitude of the sampling voltage V_{SMPL} from the time T₀ to the time T₁. Because the switch SW₆ is open and the switch SW₇ is closed during the first switching phase of the switching voltage regulator 1002, the sampling comparator 1028 is not monitoring the sampling voltage V_{SMPL}. Therefore, the first comparison signal CMP₁ is asserted at a logic-high state.

Referring to the example of FIG. 4, at the time T₁, the NFET N₃ is deactivated by the switching signal OUT₂ and the NFET N₂ is activated by the switching signal OUT₁. Therefore, the input current I_{IN} flows from the input voltage V_{IN}, through the PFET P₁, and through the inductor L₁ as the current I_{L}, and through the NFET N₂. Thus, the current I_{L} continues to increase in amplitude from the time T₁ to the time T₂ during the first switching phase of the switching voltage regulator 1002. Additionally, with reference to the example of FIG. 12, the switch SW₁ is opened by the switching signal S₁, the switches SW₄, SW₇, and SW₈ remain closed, the switch SW₂ is closed by the switching signal S₂, and one of the switches SW₃ and SW₉ is closed by the respective one of the switching signals S₃ and S₉, depending on the operational mode of the switching voltage regulator 1002.

For example, for the buck mode operation of the timing diagram 402 (and the timing diagram 302 in the example of FIG. 3), the switch SW₃ is closed. However, for the boost mode operation shown in the timing diagram 304 in the example of FIG. 3, the switch SW₉ is closed instead. Therefore, the amplitude of the current I₃ is added to the amplitude of the current I₂ at the sampling node 1016 for a buck mode of operation, or the amplitude of the current I₃ is subtracted from the amplitude of the current I₂ in the boost mode of operation. While the example of FIG. 12 shows both switches SW₃ and SW₉ as being concurrently closed, only one of the switches SW₃ and SW₉ is closed at a given time, depending on the operational mode of the switching voltage regulator 1002. Therefore, the current I₁ can be the charging current I_{CH} that is provided to the sampling node 1016 from the time T₀ to the time T₁, and the combination of the currents I₂ and I₃ (additive or subtractive) can be the charging current I_{CH} that is provided to the sampling node 1016 from the time T₁ to the time T₂.

Based on the closure of the switch SW₄, the charging current I_{CH} is provided to the sampling node 1016 during the first switching phase of the switching voltage regulator 1002. While the charging current I_{CH} is provided to the sampling node 1016, based on the closure of the switch SW₈, the reference current I_{REF} flows from the sampling node 1016. As a result, a sampling current I_{SMPL} is provided through the sampling capacitor C_{S}. The current I_{SMPL} therefore has an amplitude that is equal to the charging current I_{CH} minus the reference current I_{REF}. Thus, the sampling current I_{SMPL} begins charging the sampling capacitor C_{S} to increase the amplitude of the sampling voltage V_{SMPL}. Because the switch SW₆ is open and the switch SW₇ is closed during the first switching phase of the switching voltage regulator 1002, the sampling comparator 1028 is not monitoring the sampling voltage V_{SMPL}. Therefore, the first comparison signal CMP₁ is asserted at a logic-high state.

Referring back to the example of FIG. 4, the switching voltage regulator 1002 switches from the first switching phase to the second switching phase at the time T₂. At the time T₂, the PFET P₁ is deactivated and the NFET N₁ is activated by the switching signals IN₁ and IN₂, respectively, and the NFET N₂ remains activated. Additionally, with reference to the example of FIG. 13, the switches SW₂, SW₃, SW₉, SW₄, and SW₇ are opened by the switching signals S₁, S₃, S₉, S₄, and S₇, respectively, and the switch SW₆ is closed by the switching signal S₆. The switch SW₈ remains closed during the second switching phase of the switching voltage regulator 1002. Therefore, the current I_{IN} ceases, and the current I_{L} flows from the low-voltage rail, through the NFET N₁, through the inductor L₁, and through the NFET N₂. Thus, in the example of FIG. 4, the current I₁, is demonstrated as decreasing from the amplitude I₁₂ to an amplitude I_{L3} at a time T₃. At the time T₃, the NFET N₂ is deactivated by the switching signal OUT₁ and the NFET N₃ is activated by the switching signal OUT₂. Therefore, the current I_{L} flows from the low-voltage rail, through the NFET N₁, through the inductor L₁, and through the NFET N₃. Thus, in the example of FIG. 4, the current I_{L} is demonstrated as decreasing from the amplitude I_{L3} to the initial amplitude I_{L0} at a time T₄.

With reference to the example of FIG. 13, in the second switching phase of the switching voltage regulator 1002, the currents I₁, I₂, and I₃ cease. Therefore, the charging current I_{CH} ceases to flow to the sampling node 1016. However, the reference current I_{REF} continues to flow from the sampling node 1016, resulting in the current I_{REF} continuing to draw charge from the sampling capacitor C_{S}. As a result, the sampling voltage V_{SMPL} decreases beginning at the time T₂ during the second switching phase of the switching voltage regulator 1002.

Due to the closure of the switch SW₆, the sampling comparator 1028 compares the sampling voltage V_{SMPL} at the sampling node 1016 with the voltage at the node 1018, and therefore monitors the voltage across the sampling capacitor C_{S}. Responsive to the sampling voltage V_{SMPL} having an amplitude of approximately zero, and thus the sampling capacitor C_{S} has approximately zero charge, the sampling comparator 1028 can de-assert the first comparison signal CMP₁. Responsive to the de-assertion of the first comparison signal CMP₁, and responsive to a logic-low amplitude of the second comparison signal CMP₂ as provided by the reference comparator 1034 (e.g., responsive to the reference voltage V_{REF} being greater than the output voltage V_{OUT}), the state machine 1032 can change the state of the switching signals IN, OUT, and S. Therefore, the state machine 1032 can switch the switching voltage regulator 1002 from the second switching phase to the first switching phase, and thus the beginning of a next switching period. Therefore, the state machine 1032 can dictate the time duration of the switching periods of the switching voltage regulator 1002 based on the amplitude of the input current I_{IN} relative to the reference current I_{REF} (e.g., based on the sampling voltage V_{SMPL}) to regulate the amplitude of the input current I_{IN}.

Similar to as described above, upon completion of a switching period, the state machine 1032 can implement an idle (e.g., sleep) mode for the power supply circuit 1000, such as based on a deactivation mode for the power supply circuit 1000 or for a discontinuous mode of operation for the switching voltage regulator 1002. For example, during an idle mode, the switch SW₈ is opened by the switching signal S₅ to cease the flow of the reference current I_{REF}, and the switch SW₅ is closed by the switching signal S₈ to provide zeroing of the sampling capacitor C_{S}. The switch SW₆ can remain closed to latch the first comparison signal CMP₁ provided by the sampling comparator 1028. The state machine 1032 therefore can await a change in state of the second comparison signal CMP₂ to begin a next switching period.

Accordingly, the examples of FIGS. 7-13 describe other examples of a power supply circuit that can regulate the input current Is based on the amplitude of the input current I_{IN} relative to the reference current I_{REF} (e.g., based on the sampling voltage V_{SMPL}). Therefore, similar to the power supply circuit 200, the power supply circuits 700 and 1000 can regulate the amplitude of the input current I_{IN} in a manner that is more effective than input current regulation in a typical power supply circuit. For example, as described above, the current regulation of the power supply circuits 700 and 1000 is implemented for more complex waveforms of the inductor current I_{L}, as well as non-zero initial amplitudes of the inductor current I_{L}. Additionally, the power supply circuit 700 provides real-time measurement of the input current I_{IN} during each cycle of the switching voltage regulator 702, and thus an amplitude of the inductor current I_{L}, in an open-loop manner that negates the need for bandwidth-limiting stability compensation. Alternatively, the power supply circuit 1000 provides measurement of an estimated amplitude of the input current I_{IN} at each cycle of the switching voltage regulator 1002 to provide for a more simplistic circuit that can achieve superior regulation of the input current I_{IN} relative to a typical power supply circuit. Accordingly, the input current regulation provided by the power supply circuits 700 and 1000 can be substantially more effective than input current regulation of a typical power supply circuit.

In this description, the term “couple” may cover connections, communications, or signal paths that enable a functional relationship consistent with this description. For example, if device A generates a signal to control device B to perform an action, then: (a) in a first example, device A is directly coupled to device B; or (b) in a second example, device A is indirectly coupled to device B through intervening component C if intervening component C does not substantially alter the functional relationship between device A and device B, so device B is controlled by device A via the control signal generated by device A.

Also, in this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Furthermore, a circuit or device described herein as including certain components may instead be configured to couple to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be configured to couple to at least some of the passive elements and/or the sources to form the described structure, either at a time of manufacture or after a time of manufacture, such as by an end user and/or a third party.

Modifications are possible in the described embodiments, and other embodiments are possible, within the scope of the claims.

What is claimed is:

1. A system comprising:
a switching voltage regulator;
a current regulator coupled to the switching voltage regulator, wherein the current regulator includes:
a first current source;
a current mirror coupled to the first current source;
a second current source coupled to the current mirror;
a capacitor including a first terminal and a second terminal, wherein the first terminal is coupled to the first current source and the current mirror; and
a comparator including a first input coupled to the first terminal of the capacitor, a second input, and an output; and
a controller coupled to the switching voltage regulator and the output of the comparator.

2. The system of claim 1, wherein:
the first current source includes a first transconductance amplifier configured to generate a first current.

3. The system of claim 2, wherein:
the second current source includes a second transconductance amplifier configured to generate a second current.

4. The system of claim 3, wherein:
the second current is based on a third current and a maximum average amplitude of an input current.

5. The system of claim 3, wherein:
the current mirror includes a first terminal coupled to the first current source and a second terminal coupled to the second current source; and
the current mirror is configured to mirror the second current from the first terminal of the current mirror to the first terminal of the current mirror.

6. The system of claim 3, wherein:
an amplitude of a sample current is based on the first current minus the second current.

7. The system of claim 1, further comprising:
a first switch including a first terminal coupled to the first terminal of the capacitor, and a second terminal coupled to the first input of the comparator; and
a second switch including a first terminal coupled to the first input of the comparator, and a second terminal coupled to the second input of the comparator and the second terminal of the capacitor.

8. The system of claim 7, wherein:
in a first phase of operation, the first switch is open and the second switch is closed; and
the comparator is configured to assert a logic-high state.

9. The system of claim 8, wherein:
in a second phase of operation, the first switch is closed and the second switch is open; and
the comparator is configured to de-assert the logic-high state.

10. A circuit comprising:
a first transconductance amplifier including an output;
a second transconductance amplifier including an output;
a current mirror including a first terminal coupled to the output of the first transconductance amplifier and a second terminal coupled to the output of the second transconductance amplifier;
a first capacitor including a first terminal coupled to the first terminal of the current mirror; and
a comparator coupled to the first capacitor.

11. The circuit of claim 10, wherein:
the current mirror includes a first transistor, a second capacitor, and a second transistor;
the first transistor includes a first terminal, a second terminal, and a control terminal;
the second transistor includes a first terminal, a second terminal, and a control terminal; and
the second capacitor includes a first terminal coupled to the control terminal of the first transistor and the control terminal of the second transistor, and a second terminal coupled to a ground.

12. The circuit of claim 11, further comprising:
a first switch including a first terminal coupled to the output of the first transconductance amplifier, and a second terminal coupled to the first terminal of the first transistor; and
a second switch including a first terminal coupled to the output of the second transconductance amplifier, and a second terminal coupled to the first terminal of the second transistor.

13. The circuit of claim 12, further comprising:
a third transistor including a first terminal coupled to a first input of the second transconductance amplifier, and a second terminal coupled to second input of the second transconductance amplifier; and
a third switch including a first terminal coupled to the first terminal of the third transistor, and a second terminal.

14. The circuit of claim 13, wherein:
the second terminal of the third switch is configured to be coupled to a current.

15. The circuit of claim 14, further comprising:
a fourth switch including a first terminal coupled to the first terminal of the first capacitor, and a second terminal coupled to the first input of the comparator; and
a fifth switch including a first terminal coupled to the first input of the comparator, and a second terminal coupled to the second input of the comparator and the second terminal of the first capacitor.

16. The circuit of claim 15, further comprising:
a sixth switch including a first terminal coupled to the first terminal of the second capacitor, and a second terminal coupled to the control terminal of the second transistor.

17. The circuit of claim 16, wherein:
in a first phase of operation, the first switch, the second switch, the third switch, the fifth switch, and the sixth switch are closed; and
in the first phase of operation, the fourth switch is open.

18. The circuit of claim 17, wherein:
in a second phase of operation, the first switch, the second switch, the third switch, the fifth switch, and the sixth switch are open; and
in the second phase of operation, the fourth switch is closed.

19. An apparatus comprising:
a switching voltage regulator;
a current regulator coupled to the switching voltage regulator, wherein the current regulator includes:
a first transconductance amplifier including an output;
a second transconductance amplifier including an output;
a current mirror including a first terminal coupled to the output of the first transconductance amplifier and a second terminal coupled to the output of the second transconductance amplifier;
a first capacitor including a first terminal coupled to the first terminal of the current mirror; and
a comparator coupled to the first capacitor; and
a controller coupled to the switching voltage regulator and the output of the comparator.

20. The apparatus of claim 19, wherein:
the current regulator is configured to generate a first current, generate a second current based on a reference current, and generate a third current; and
the third current is approximately equal to the first current minus the second current.
